(19) United States
(12) Patent Application Publication
(10) Pub. No.: US 2010/0149474 A1
(43) Pub. Date: Jun. 17, 2010

(54) LIQUID CRYSTAL DISPLAY DEVICE

(76) Inventor: Masumi Kubo, Ikoma-shi (JP)

Correspondence Address: NIXON & VANDERHYE, PC, 901 NORTH GLEBE ROAD, 11TH FLOOR, ARLINGTON, VA, 22203, US

(21) Appl. No.: 11/996,990

(22) PCT Filed: Jul. 31, 2006
(86) PCT No.: PCT/JP2006/315141

§ 371 Date: Jan. 28, 2008

(30) Foreign Application Priority Data
Aug. 1, 2005 (JP) 2005-222643

(51) Int. Cl. G02F 1/1337

(52) U.S. Cl. 349/123

(57) ABSTRACT

A liquid crystal display device according to the present invention includes a picture element region defined by a first electrode 14 provided on a surface of a first substrate, the surface being on the side of a liquid crystal layer 30, and a second electrode 22 provided on a second substrate 21 and facing the first electrode with the liquid crystal layer interposed therebetween. In the picture element region, the first electrode 14 includes a solid area 14b formed of a conductive layer and a non-solid area 14a, 14a′ with no conductive layer. The solid area includes a plurality of unit solid areas 14b′ each substantially surrounded by the non-solid area; and each of the plurality of unit solid areas 14b′ has a recess 15a, concaved in a thickness direction of the liquid crystal layer, at a substantially central position thereof. When a voltage is applied between the first electrode and a second electrode, the liquid crystal layer forms a liquid crystal domain taking a radially inclined alignment in correspondence with each of the plurality of unit solid areas 14b′ by an oblique electric field generated in an edge of the non-solid area, and also locates a center of the radially inclined alignment in the recess 15a.

### TECHNICAL FIELD

The present invention relates to a liquid crystal display device, and specifically to a liquid crystal display device having a wide viewing angle and providing high quality display.

### BACKGROUND ART

Recently, liquid crystal display devices having a wide viewing angle have been developed and widely used as monitors of personal computers, display devices of mobile information terminals, and TV receivers.

One type of liquid crystal display devices having a wide viewing angle uses a liquid crystal display device of a vertical alignment type (referred to as the “VA mode”). The applicant of the present application discloses a VA mode liquid crystal display device having a viewing angle characteristic improved by forming domains taking a radially inclined alignment upon application of a voltage in Patent Documents 1 and 2. In such a liquid crystal display device, a plurality of radially inclined alignment domains are formed in each of picture elements when a voltage is applied, and the alignment directions liquid crystal molecules in adjacent radially inclined alignment domains are continuous to each other. The applicant of the present application refers to the liquid crystal display mode using such a characteristic alignment state disclosed in Patent Documents 1 and 2 as the Continuous Pinwheel Alignment (CPA) mode (Non-patent Document 1).

Patent Document 1 discloses a structure by which a non-solid area (area having no conductive layer; opening) is provided in a picture element electrode and a radially inclined alignment is formed by using an oblique electric field generated in an edge of the non-solid area in the picture element electrode when a voltage is applied. Also disclosed is a structure provided in order to stabilize the radially inclined alignment. By this structure, an alignment regulating structure is provided on a substrate which faces the picture element electrode with the liquid crystal layer interposed therebetween, more specifically on a surface of the substrate on the side of the liquid crystal layer (see, for example, Patent Document 1, FIG. 27). As an example of such an alignment regulating structure, a projection which projects into the liquid crystal layer is described (see, for example, Patent Document 1, FIG. 24(b)).

The liquid crystal display device disclosed in Patent Document 2 includes a picture element electrode including an upper conductive layer and a lower conductive layer facing each other with a dielectric layer interposed therebetween. Like the picture element electrode in Patent Document 1, the upper conductive layer located on the side of the liquid crystal layer has an opening (non-solid area), and a radially inclined alignment domain is formed by using an oblique electric field generated in an edge of the opening when a voltage is applied. The lower conductive layer is located in a region facing at least the opening of the upper conductive layer, and prohibits an excessive decrease in the voltage applied to the liquid crystal layer in a region corresponding to the opening of the upper conductive layer (see, for example, Patent Document 2, FIG. 11). Patent Document 2 also discloses a structure by which the radially inclined alignment is stabilized by an alignment regulating structure provided on a substrate which faces the picture element electrode (upper conductive layer) with the liquid crystal layer interposed therebetween, more specifically on a surface of the substrate on the side of the liquid crystal layer (see, for example, Patent Document 2, FIG. 30).

The liquid crystal display devices disclosed in these patent documents stabilize the radially inclined alignment by an alignment regulating structure provided on a substrate which faces the picture element electrode, more specifically on a surface of the substrate on the side of the liquid crystal layer. Therefore, these liquid crystal display devices offer effects of realizing high quality display over a wide range of gradation and making it difficult to generate afterimages even if a stress is applied to the liquid crystal display panel.

Patent Document 1: Japanese Laid-Open Patent Publication No. 2002-202511

Patent Document 2: Japanese Laid-Open Patent Publication No. 2002-55343

Non-patent Document 1: Kubo et al., Sharp Technical Journal, No. 80, pages 11-14 (August 2001)

### DISCLOSURE OF THE INVENTION

### Problems to be Solved by the Invention

However, the liquid crystal display device disclosed in each of Patent Documents 1 and 2 has a problem that the production cost is raised because an alignment regulating structure (for example, projection) needs to be formed on a substrate facing the electrode including a non-solid area (for example, opening) for generating an oblique electric field in order to stabilize the alignment of the liquid crystal molecules. For example, an alignment regulating structure needs to be formed on a counter substrate located to face a TFT substrate on which a picture element electrode having an opening is formed (the counter substrate is typically a color filter substrate). This causes the problems that the number of production steps of the counter substrate is increased and the production cost is raised.

The present invention made to solve the above-described problems has a main object of stabilizing the radially inclined alignment by providing an alignment regulating structure on a substrate on which an electrode having a non-solid area is formed.

### Means for Solving the Problems

A liquid crystal display device according to the present invention comprises a first substrate, a second substrate, and a liquid crystal layer of a vertical alignment type provided between the first substrate and the second substrate; and a picture element region defined by a first electrode provided on a surface of the first substrate, the substrate being on the side of the liquid crystal layer, and a second electrode provided on the second substrate and facing the first electrode with the liquid crystal layer interposed therebetween. In the picture element region, the first electrode includes a solid area formed of a conductive layer and a non-solid area with no conductive layer; the solid area includes a plurality of unit solid areas each substantially surrounded by the non-solid area; and each of the plurality of unit solid areas has a recess, concaved in a thickness direction of the liquid crystal layer, at a substantially central position thereof. When a voltage is applied between the first electrode and a second electrode, the liquid crystal layer forms a liquid crystal domain taking a radially inclined alignment in correspondence with each of the plurality of unit solid areas by an oblique electric field generated in an edge of the non-solid area, and also locates a center of the radially inclined alignment in the recess.

In one embodiment, the liquid crystal display device includes a dielectric layer provided in the picture element region on a surface of the first electrode, the surface being on the side of the first substrate; the dielectric layer has a recess or a hole; and the plurality of unit solid areas each have the recess in correspondence with the recess or the hole of the dielectric layer.

In one embodiment, the liquid crystal display device further comprises a third electrode in the picture element region, the third electrode facing the non-solid area of the first electrode with the dielectric layer interposed therebetween.

In one embodiment, the dielectric layer has at least one hole exposing the third electrode; and at least one of the plurality of unit solid areas is connected to the third electrode in the at least one hole.

In one embodiment, the alignment of the liquid crystal domain and the alignment in a region of the liquid crystal layer corresponding to the non-solid area are continuous to each other.

In one embodiment, the non-solid area has an opening substantially surrounded by the plurality of unit solid areas; and when a voltage is applied between the first electrode and the second electrode, the liquid crystal layer forms a liquid crystal domain taking a radially inclined alignment also in a region of the liquid crystal layer corresponding to the opening.

In one embodiment, in the picture element region, the second electrode has a continuous surface which is parallel to a surface of the second substrate.

In one embodiment, when no voltage is applied between the first electrode and the second electrode, liquid crystal molecules in a region of the liquid crystal layer on the side of the second electrode are aligned substantially vertical to a surface of the second substrate.

### EFFECTS OF THE INVENTION

In a liquid crystal display device according to the present invention, the electrode having a non-solid area has a recess, concaved in a thickness direction of the liquid crystal layer, at a substantially central position of a solid area. In the recess, the center of a radially inclined alignment is formed. Therefore, even without providing an alignment regulating structure on a substrate facing the electrode, the radially inclined alignment can be stabilized. Hence, a liquid crystal display device with a sufficiently stable radially inclined alignment can be provided without increasing the number of production steps of the counter substrate or raising the production cost.

### BRIEF DESCRIPTION OF THE DRAWINGS

FIGS. 1(a) and 1(b) schematically show a structure of a liquid crystal display device 100 in an embodiment according to the present invention; FIG. 1(a) is a plan view of a picture element region of the liquid crystal display device 100, and FIG. 1(b) is a cross-sectional view taken along line 1B-1B′ in FIG. 1(a).

FIGS. 2(a) through 2(c) show a mechanism by which a radially inclined alignment domain is stably formed in the liquid crystal display device 100; FIG. 2(a) shows an alignment state of liquid crystal molecules where no voltage is applied; FIG. 2(b) shows the alignment state in an initial ON state; and FIG. 2(c) shows the alignment state in a steady state.

FIGS. 3(a) and 3(b) schematically show a structure of a liquid crystal display device 200 in another embodiment according to the present invention; FIG. 3(a) is a plan view of a picture element region of the liquid crystal display device 200, and FIG. 3(b) is a cross-sectional view taken along line 3B-3B′ in FIG. 3(a).

FIGS. 4(a) through 4(c) show a mechanism by which a radially inclined alignment domain is stably formed in the liquid crystal display device 200; FIG. 4(a) shows an alignment state of liquid crystal molecules where no voltage is applied; FIG. 4(b) shows the alignment state in an initial ON state; and FIG. 4(c) shows the alignment state in a steady state.

FIGS. 5(a) and 5(b) show another example of the picture element electrode included in a liquid crystal display device in an embodiment according to the present invention.

FIGS. 6(a) and 6(b) show still another example of the picture element electrode included in a liquid crystal display device in an embodiment according to the present invention.

FIGS. 7(a) and 7(b) schematically show a corner of a unit solid area of a picture element electrode included in a liquid crystal display device in an embodiment according to the present invention.

FIG. 8 shows still another example of the picture element electrode included in a liquid crystal display device in an embodiment according to the present invention.

### DESCRIPTION OF THE REFERENCE NUMERALS

11, 21 Transparent substrate (glass substrate)
12 Lower electrode
12a Connecting line
13 Dielectric layer (inter-layer insulating film)
13a Hole (recess)
14 Picture element electrode (upper electrode)
14a Opening
14a′ Cutout area
14b Solid area
14b′ Unit solid area
15a Recess
22 Counter electrode
30 Liquid crystal layer
30a Liquid crystal molecule
100, 200 Liquid crystal display device
100a, 200a TFT substrate
100b, 100b Counter substrate

### BEST MODE FOR CARRYING OUT THE INVENTION

Hereinafter, a structure and an operation of a liquid crystal display device in an embodiment according to the present invention will be described with reference to the drawings. The present invention is not limited to the embodiments described below.

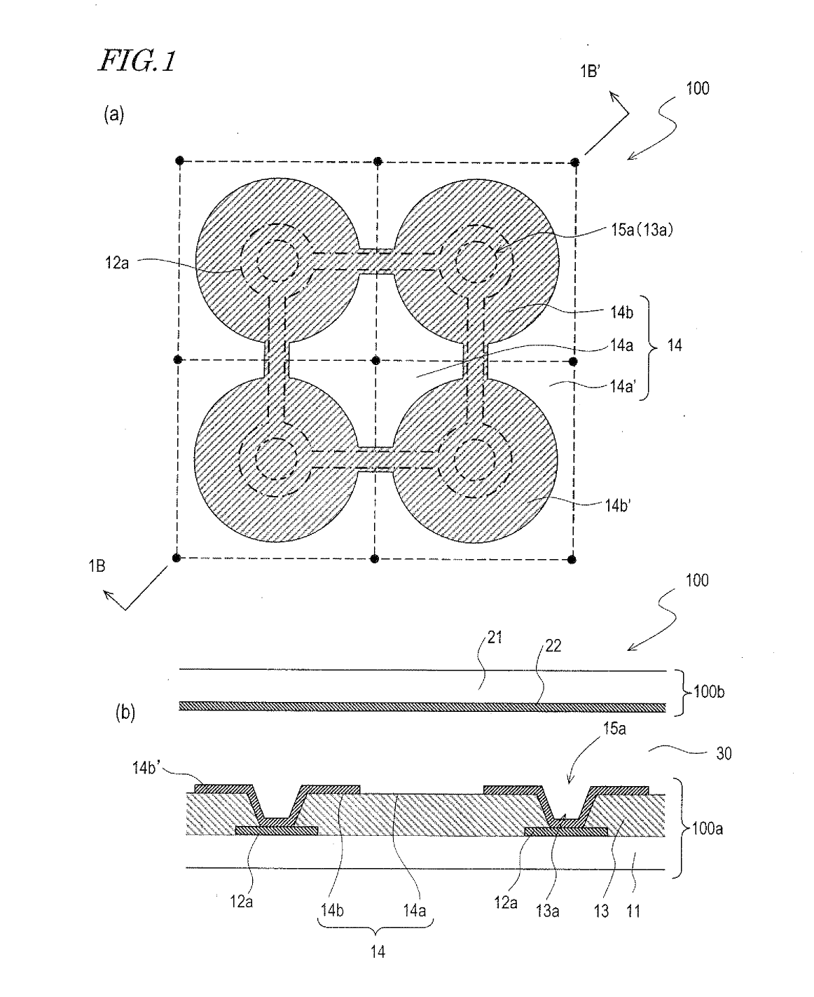

FIGS. 1(a) and 1(b) schematically show a structure of a liquid crystal display device 100 in an embodiment according to the present invention. For the sake of simplicity, FIGS. 1(a) and 1(b) schematically show a structure of an electrode in one picture element region of the liquid crystal display device 100 and omit structural details. FIG. 1(a) is a plan view of the picture element region of the liquid crystal display device 100, and FIG. 1(b) is a cross-sectional view taken along line 1B-1B′ in FIG. 1(a). Herein, the term “picture element region” refers to a region of the liquid crystal display device corresponding to a “picture element (dot)” in display. In a color liquid crystal display device, for example, a region corresponding to each “picture element” of red (R), green (G) or blue (B) is a “picture element region”. In an active matrix liquid crystal display device, a picture element electrode and a counter electrode facing the picture element electrode define a picture element region.

The liquid crystal display device 100 includes an active matrix substrate (hereinafter, referred to as a “TFT substrate”) 100a, a counter substrate (referred to also as a “color filter substrate”) 100b, and a liquid crystal layer 30 provided between the TFT substrate 100a and the counter substrate 100b. Liquid crystal molecules in the liquid crystal layer 30 have a negative dielectric anisotropy. When no voltage is applied across the liquid crystal layer 30, the liquid crystal molecules are aligned vertical to a surface of, and by virtue of, a vertical alignment film (not shown) provided on a surface of each of the TFT substrate 100a and the counter substrate 100b, the surface being on the side of the liquid crystal layer 30. In this state, the liquid crystal layer 30 is expressed as being in a “vertical alignment state”. The liquid crystal molecules in the liquid crystal layer 30 in the vertical alignment state may occasionally be slightly inclined with respect to the normal to the surface of each vertical alignment film (the surface of each substrate) depending on the type of vertical alignment film or the type of liquid crystal material. Generally, a state where the axis of liquid crystal molecules (referred to also as an “axial orientation”) is aligned at an angle of about 85 degrees or greater with respect to the surface of the vertical alignment film is referred to as the “vertical alignment state”.

The TFT substrate 100a of the liquid crystal display device 100 includes a transparent substrate (for example, a glass substrate) 11 and a picture element electrode 14 provided on a surface thereof. The counter substrate 100b includes a transparent substrate (for example, a glass substrate) 21 and a counter electrode 22 provided on a surface thereof. The alignment state in the liquid crystal layer 30 in each picture element region changes in accordance with the voltage applied between the picture element electrode 14 and the counter electrode 22, which are arranged to face each other with the liquid crystal layer 30 interposed therebetween. An image is displayed by utilizing the phenomenon that the polarization state or amount of light transmitting through the liquid crystal layer 30 changes along with a change in the alignment state in the liquid crystal layer 30.

The picture element electrode 14 of the liquid crystal display device 100 includes an opening 14a, a cutout area 14a′ and a solid area 14b. In the picture element electrode 14 formed of a conductive film (for example, an ITO film), the opening 14a and the cutout area 14a′ are areas from which the conductive film has been removed, and the solid area 14b is an area where the conductive film is existent (the area other than the opening 14a). Both of the opening 14a and the cutout area 14a′ may occasionally be referred to as a “non-solid area”. Each picture element electrode 14 includes one opening 14a in this example, but as described below, each picture element electrode may include a plurality of openings 14a or may include no opening 14a. Even with no opening 14a, a plurality of areas taking a radially inclined alignment can be formed, in each picture element region. The solid area 14b is basically formed of one continuous conductive film. The counter electrode 22 is formed of one conductive layer, which has a continuous surface parallel to the surface of the substrate 21 and is typically provided on the entirety of the display area.

The square represented with the dashed line in FIG. 1(a) (an assembly of four square lattices) shows a region (contour) corresponding to the conventional picture element electrode formed of one conductive layer, and corresponds to the contour of this picture element region. A solid area which is located at the center of each of the four square lattices formed in the picture element region and is substantially surrounded by the non-solid area may occasionally be referred to as a “unit solid area”.

When a voltage is applied across the liquid crystal layer 30 by the picture element electrode 14 and the counter electrode 22, a radially inclined alignment domain is formed in correspondence with each unit solid area 14b′ by an oblique electric field generated in an edge of the solid area (the edge being defined by the non-solid area). In a region corresponding to the opening 14a surrounded by the unit solid areas 14b′, a radially inclined alignment domain, in which the liquid crystal molecules are inclined oppositely to that of the radially inclined alignment domain formed in correspondence with the unit solid area 14b′, is formed. The alignment of the liquid crystal molecules in the radially inclined alignment domain corresponding to the unit solid area 14b′ can be compared to an umbrella opened upward, whereas the alignment of the liquid crystal molecules in the radially inclined alignment domain corresponding to the opening 14a can be compared to an umbrella opened downward. Therefore, the inclination direction of the liquid crystal molecules in the radially inclined alignment domain formed in correspondence with each unit solid area 14b′, and the inclination direction of the liquid crystal molecules in the radially inclined alignment domain formed in correspondence with the opening 14a, match each other at the border therebetween. As a result, the alignment of the liquid crystal molecules is stabilized in the entire picture element region. Namely, the alignment in the liquid crystal domain formed in correspondence with each unit solid area 14b′, and the alignment in the region of the liquid crystal layer corresponding to the non-solid area, are continuous to each other. Therefore, the alignment of the liquid crystal molecules is stabilized in the entire picture element region.

The alignment direction of the liquid crystal molecules in a region corresponding to the cutout area 14a′ is the same as the alignment direction of the liquid crystal molecules in the region corresponding to the opening 14a. Namely, the liquid crystal molecules in the region corresponding to the cutout area 14e are inclined to match the inclination direction of the liquid crystal molecules in the radially inclined alignment domain formed in correspondence with the unit solid area 14b′ adjacent to the cutout area. The cutout area 14a′ is not surrounded by the solid area 14b unlike the opening 14a, and so the contour of the liquid crystal domain formed in correspondence with the cutout area 14a′ cannot be compared to an umbrella. Nevertheless, like the liquid crystal molecules corresponding to the opening 14a, the liquid crystal molecules corresponding to the cutout area 14a′ are aligned to match the alignment direction of the liquid crystal molecules in the radially inclined alignment domain formed in correspondence with each unit solid area 14b′, and thus are aligned in a stable manner. Regarding the generally circular unit solid area 14b′ in each of the square lattices shown in FIG. 1(a), about ¼ of the circumference thereof is defined by a side of the opening 14a, and about ¾ thereof is defined by a side of the cutout area 14a′. For aligning the liquid crystal molecules in the radially inclined alignment domain formed in correspondence with each unit solid area 14b′, it does not matter whether the contour of the unit solid area 14b′ is defined by the opening 14a or the cutout area 14a′. Thus, in the case where it is not necessary to distinguish the opening 14a from the cutout area 14a′, both of the opening 14a and the cutout area 14a′ will be referred to as the “non-solid area”.

Even without forming the opening 14a, a plurality of liquid crystal domains can be formed in one picture element region merely by forming a cutout area 14a′. For example, two unit solid areas 14b′ shown in FIG. 1(a) adjacent to each other in the vertical direction may be considered as one picture element electrode. This picture element electrode includes two unit solid areas 14b′, and forms two liquid crystal domains taking a radially inclined alignment when a voltage is applied, although including no opening 14a. As long as the picture element electrode has unit solid areas 14b′ which form a plurality of liquid crystal domains taking a radially inclined alignment when a voltage is applied (in other words, as long as the picture element electrode has such a contour), the liquid crystal molecules are aligned in a continuous manner in the picture element region. For this reason, the radially inclined alignment of the liquid crystal domains formed in correspondence with the unit solid areas 14b′ is stabilized.

In this example, the picture element region is square. The shape of the picture element region is not limited thereto. A general shape of a picture element region is approximated to a rectangle (encompassing a square and an oblong rectangle). Therefore, by regularly arranging a plurality of unit solid areas 14b′ which are congruent to one another, a plurality of radially inclined alignment domains corresponding to the unit solid areas 14b′ can be formed in a picture element region and thus the liquid crystal molecules in the picture element region can be stably aligned. Although unit solid areas 14b′ which are different in size or shape may be formed depending on the shape of the picture element region, the contour of each unit solid area preferably has at least a four-fold rotational symmetry from the viewpoint of the viewing angle characteristic. With at least a four-fold rotational symmetry, a transmissive liquid crystal display device of a normally black mode can provide an equivalent display characteristic (viewing angle characteristic) in four azimuth angle areas defined by transmission axes of a pair of polarization plates located in a crossed-Nicols state (four areas separated by the cross).

As schematically shown in FIGS. 1(a) and 1(b), the picture element electrode 14 included in the liquid crystal display device 100 in this embodiment has a recess 15a, concaved in a thickness direction of the liquid crystal layer 30, substantially at the center of each unit solid area 14b′. The recess 15a acts to locate the center of the radially inclined alignment domain, formed in correspondence with the unit solid area 14b′ when a voltage is applied, in the recess 15a. Accordingly, the radially inclined alignment is stabilized by the effect provided by the shape of the recess 15a (the effect provided by the shape of the cross-section of the recess 15a) as well as by the influence of the oblique electric field generated in an edge of the unit solid area 14b′. The oblique electric field acts to regulate the alignment of the liquid crystal molecules in a peripheral portion of the radially inclined alignment domain, whereas the recess 15a acts to regulate the alignment of the liquid crystal molecules in a central area of the radially inclined alignment domain. As a result, the alignment of the liquid crystal molecules in the radially inclined alignment domain is further stabilized. Accordingly, the alignment of the liquid crystal molecules, even if disturbed by a stress applied to the liquid crystal panel, is recovered to the original state in a short time. Moreover, since the center of the radially inclined alignment domain is formed and secured in the recess 15a with certainty, the recovered alignment state is always substantially the same. Since the center of the radially inclined alignment domain is formed in each recess 15a with certainty, an effect of suppressing the variance in the viewing angle characteristic among the picture elements is also provided. Unlike in Patent Document 1 or 2 described above, no alignment regulating structure is provided on a substrate which faces the picture element electrode, more specifically on a surface of the substrate on the side of the liquid crystal layer. Therefore, the problems that the number of production steps of the counter substrate is increased and the production cost is raised do not occur.

As shown in FIG. 1(b), the recesses 15a of the picture element electrode 14 are formed by, for example, forming the picture element electrode 14 so as to cover holes 13a in a dielectric layer (inter-layer insulating film) 13 which is formed below the picture element electrode 14 (on a surface of the picture element electrode 14, the surface being on the side of the transparent substrate 11). The dielectric layer 13 has the holes 13a in this example, but may have recesses. The holes 13a in this example are provided so as to expose a connecting line (an extending portion of a drain electrode) provided below the dielectric layer 13, and acts also as contact holes each forming a contact section for electrically connecting the connecting line 12a and the picture element electrode 14 to each other. Although omitted in FIG. 1 for the sake of simplicity, the dielectric layer 13 on the transparent substrate 11 is provided so as to cover a TFT, a gate bus line connected to a gate electrode of the TFT, a source bus line connected to a source electrode of the TFT, and a storage capacitance (CS) and a storage capacitance bus line (CS bus line) provided when necessary. Instead of the TFT, other switching elements such as an MIM or the like may occasionally be provided. Where the dielectric layer 13 is provided so as to cover the TFT, the bus lines and the like as in this embodiment, the picture element electrode 14 can be provided such that a peripheral portion of the picture element electrode 14 overlaps a part of the bus lines. This is advantageous in increasing the area ratio contributing the display (the numerical aperture of the picture element).

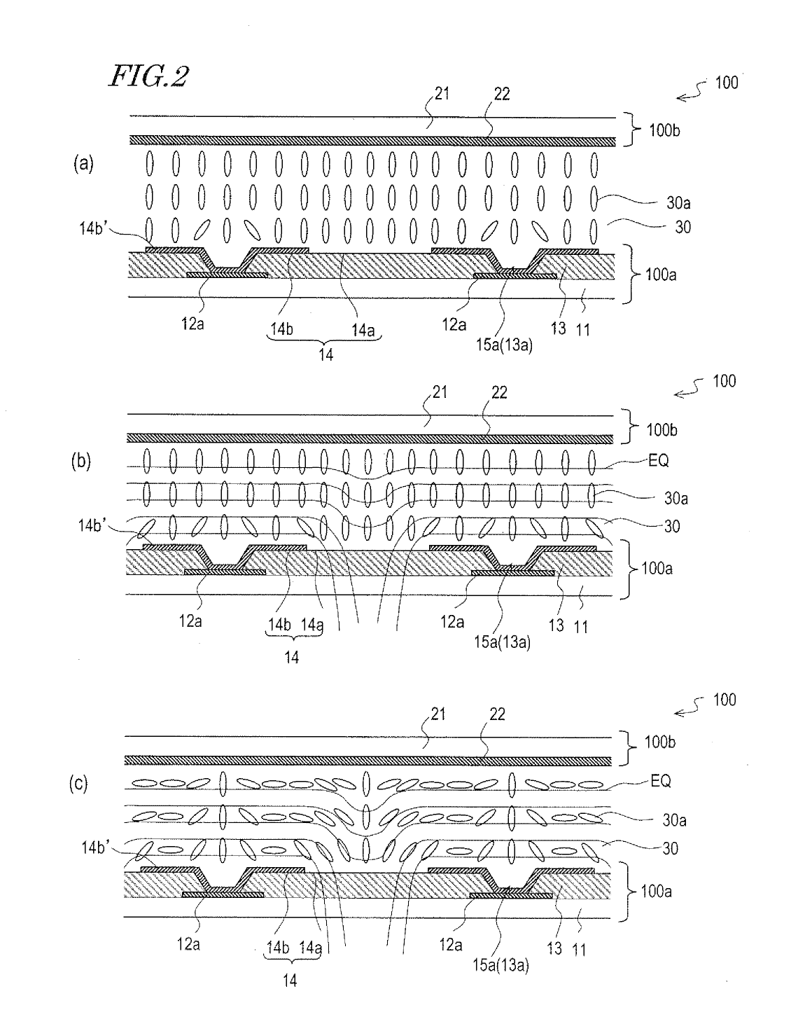

With reference to FIGS. 2(a) through 2(c), a mechanism by which the radially inclined alignment domains are stably formed in the liquid crystal display device 100 will be described. FIG. 2(a) schematically shows a state where no voltage is applied across the liquid crystal layer 30. FIG. 2(b) schematically shows a state where the alignment of the liquid crystal molecules 30a has just started to change (initial ON state) in accordance with the voltage applied across the liquid crystal layer 30. FIG. 2(c) schematically shows a state where the alignment of the liquid crystal molecules 30a, which has been changing in accordance with the applied voltage, has reached a steady state. In FIGS. 2(b) and 2(c), curves EQ represent equipotential lines.

As shown in FIG. 2(a), where no voltage is applied, the liquid crystal molecules 30a are aligned vertical to a surface of the vertical alignment film (not shown) provided on a surface of each of the TFT substrate 100a and the counter substrate 100b, the surface being on the side of the liquid crystal layer 30. The liquid crystal molecules 30a in the vicinity of each recess 15a tend to be aligned substantially vertical to an inclined surface of the recess 15a (more strictly, the surface of the vertical alignment film on the inclined surface) and so are inclined toward the center of the recess 15a. The alignment regulating force provided by the recess 15a is caused by the physical shape of the recess 15a, and so acts on the liquid crystal molecules 30a in the vicinity of the recess 15a regardless of whether a voltage is applied or not.

When a voltage is applied across the liquid crystal layer 30, a potential gradient represented by the equipotential lines EQ (perpendicularly crossing an electric force line) shown in FIG. 2(b) is produced. In a region of the liquid crystal layer 30 which is between the solid area 14b of the picture element electrode 14 and the counter electrode 22, the equipotential lines EQ are parallel to the surfaces of the solid area 14b and the counter electrode 22. The equipotential lines EQ drop in a region corresponding to the opening 14a of the picture element electrode 14. As a result, an oblique electric field represented by an inclined portion of the equipotential lines EQ is produced in a region of the liquid crystal layer 30 above each edge of the opening 14a (a peripheral portion of the opening 14a including an external boundary of the opening 14a). In a region corresponding to the cutout area 14b′ also, the equipotential lines EQ drop like in the region corresponding to the opening 14a, needless to say.

Upon the liquid crystal molecules 30a having negative dielectric anisotropy, a torque acts to direct the axial orientation of such liquid crystal molecules 30a to be parallel to the equipotential lines EQ (vertical to the electric force line) (such a torque is an alignment regulating force). Accordingly, as shown in FIG. 2(b), the liquid crystal molecules 30a above a right edge of the opening 14a incline (rotate) clockwise, and the liquid crystal molecules 30a above a left edge of the opening 14a incline (rotate) counterclockwise. As a result, the liquid crystal molecules 30a above the edges are aligned parallel to the corresponding portions of the equipotential lines EQ. Namely, the liquid crystal layer 30a corresponding to the peripheral portion of each unit solid area 14W are aligned as inclined toward the center of the unit solid area 14W. This alignment direction (inclining direction) matches the alignment direction (inclining direction) of the liquid crystal layer 30a aligned as regulated by the recess 15a formed at the center of the unit solid area 14W.

When the voltage applied across the liquid crystal layer 30 approaches a saturation voltage, as shown in FIG. 2(c), the radially inclined alignment domains are formed in a region corresponding to each unit solid area 14b′ and also in a region corresponding to the opening 14a. The liquid crystal molecules in the radially inclined alignment domain corresponding to the unit solid area 14b′ are aligned like an umbrella opened with the tip directed upward, whereas the liquid crystal molecules in the radially inclined alignment domain corresponding to the opening 14a are aligned like an umbrella opened with the tip directed downward. As shown in the figure, the alignment of the liquid crystal domain corresponding to the unit solid area 14b′ and the alignment of the liquid crystal domain corresponding to the opening 14a are continuous (matched) to each other. Therefore, the alignment of the liquid crystal molecules 30a in the liquid crystal layer 30 is stabilized.

Moreover, the center of the radially inclined alignment domain corresponding the unit solid area 14b′ is located in the recess 15a. Therefore, the radially inclined alignment domains formed in correspondence with a plurality of unit solid areas are equivalent to one another. Where radially inclined alignment domains are formed only by the alignment regulating force provided by the oblique electric field generated in an edge of the opening 14a, the central positions of the radially inclined alignment domains are not necessarily the same and may be different among the domains. Especially where the applied voltage is low, this phenomenon is conspicuous because a sufficient alignment regulating force is not provided. Where the central positions of the radially inclined alignment domains are shifted, the alignment direction of the liquid crystal molecules 30a is eccentrically distributed. This decreases the viewing angle characteristic or causes coarse-looking display. The recess 15a of the picture element electrode 14 provides a constant alignment regulating force regardless of the applied voltage, and so stabilizes the radially inclined alignment and thus can suppress the above-mentioned inconveniences.

When a stress is applied to the liquid crystal display device 100 in a steady state, the radially inclined alignment in the liquid crystal layer 30 is once destroyed. When the stress is removed, however, the liquid crystal molecules are recovered to the radially inclined alignment state owing to the alignment regulating force acting on the liquid crystal molecules 30a. This suppresses an afterimage from being generated by the stress. When the alignment regulating force provided by the recess 15a is too strong, retardation occurs due to the radially inclined alignment even where no voltage is applied. This may decrease the contrast ratio of the display. However, the alignment regulating force of the recess 15a is provided only for stabilizing the radially inclined alignment formed by the oblique electric field and securing the position of the central axis thereof. Such an alignment regulating force does not need to be strong and works sufficiently well with such a level that does not generate retardation which would decrease the display quality.

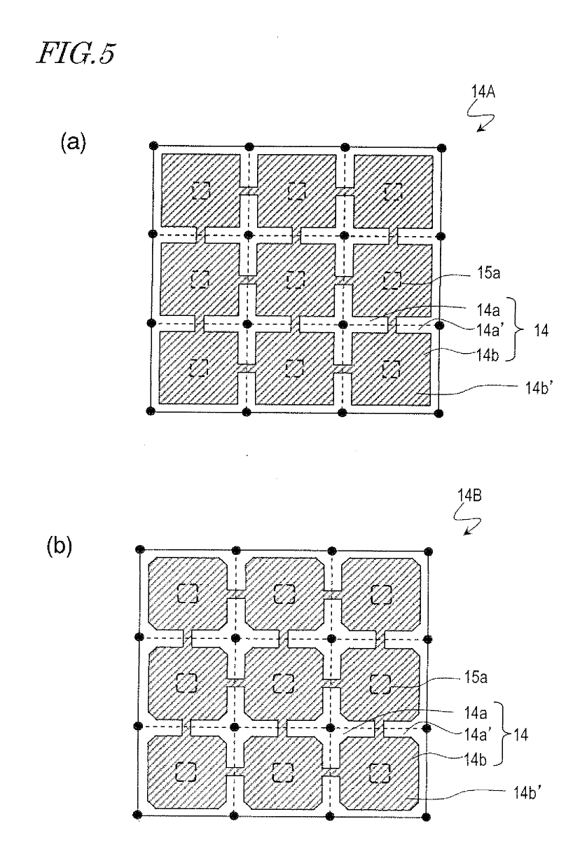

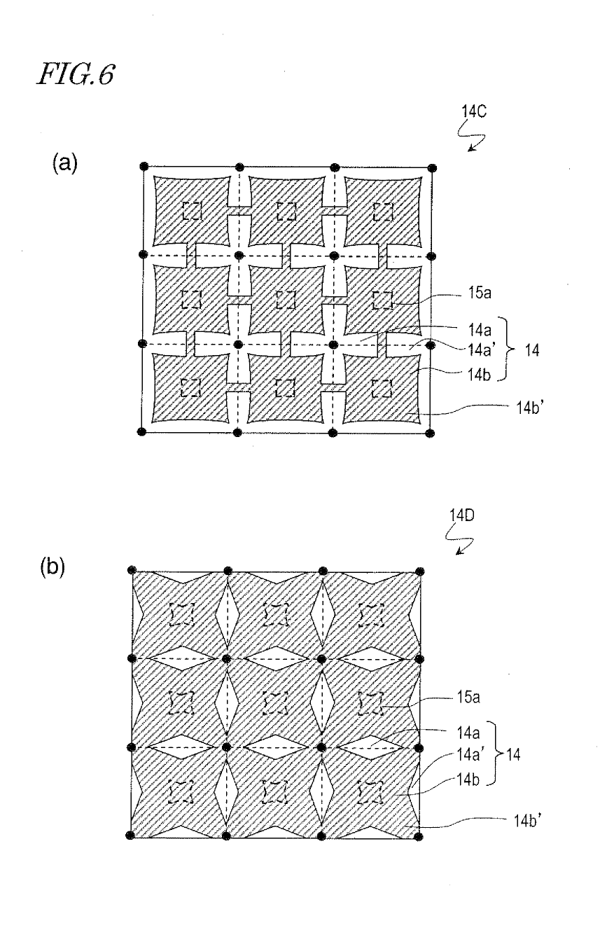

For example, a typical pixel structure (unit solid area size: 15 μm to 60 μm, especially 15 μm to 45 μm; liquid crystal layer thickness: 2 μm to 4.5 μm, especially 2.5 μm to 3.5 μm, for a transmission section of a transmissive or transreflective device; 1.0 μm to 2.3 μm, especially 1.2 μm to 1.8 μm, for a reflection section of a reflection or transreflective device) will be considered. In such a structure, the recess 15a preferably has a size (typically, the maximum width) in the range of 9 μm to 20 μm at the bottom, and preferably has a depth of 1.5 μm or greater, especially 2.5 μm or greater. The inclination angle of a side surface of the recess 15a is preferably 30 degrees or greater and 90 degrees or less with respect to the surface of the substrate. In order to effectively stabilize the alignment of the liquid crystal molecules 30a in cooperation with the alignment regulating force of the oblique electric field, it is preferable that the recess 15a is formed at the center of the unit solid area 14b′ and has a contour similar to the contour of the unit solid area 14b′. Since the unit solid area 14b′ preferably has at least a four-fold rotational symmetry as described above, the contour of the recess 15a also preferably has at least a four-fold rotational symmetry, and the rotation axes thereof preferably match each other (see FIGS. 5 and 6).

In the liquid crystal display device 100 in this example, generally circular unit solid areas 14b′ are connected to one another via thin connecting sections. The unit solid areas 14b′ only need to be electrically connected to one another so as to be supplied with the same voltage (drain voltage). In a structure where the unit solid areas 14b′ are electrically connected to one another via the connecting line 12a and the hole 13a, there is no need to connect the unit solid areas 14b′ to one another via connecting sections. In such a case, the unit solid areas 14b′ may be formed separately. Alternatively, where the unit solid areas 14b′ connected to one another via connecting sections as shown in the figure are formed, it is not necessary to connect each unit solid area 14b′ to the connecting line 12a. For example, only the unit solid area 14b′ closest to the drain electrode (not shown) of the TFT may be connected to the connecting line 12a in the recess 15a thereof. In this case, in order to form a recess 15a in each unit solid area 14b′ which is not connected to the connecting line 12a, a recess may be formed in the dielectric layer 13a instead of the hole 13a, or a hole exposing the surface of the substrate 11 may be formed in the dielectric layer 13. From the viewpoint of repairing the shortcircuiting or disconnection of the unit solid areas 14b′, it is preferable that each unit solid area 14b′ is electrically connected to the drain electrode of the TFT via a plurality of electric lines.

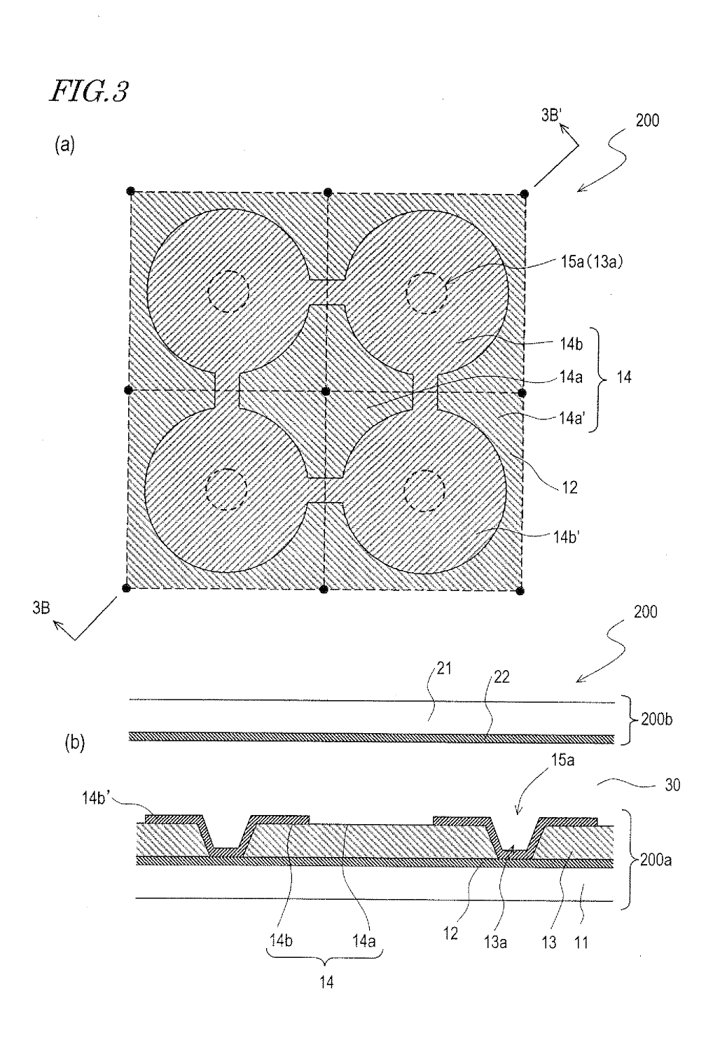

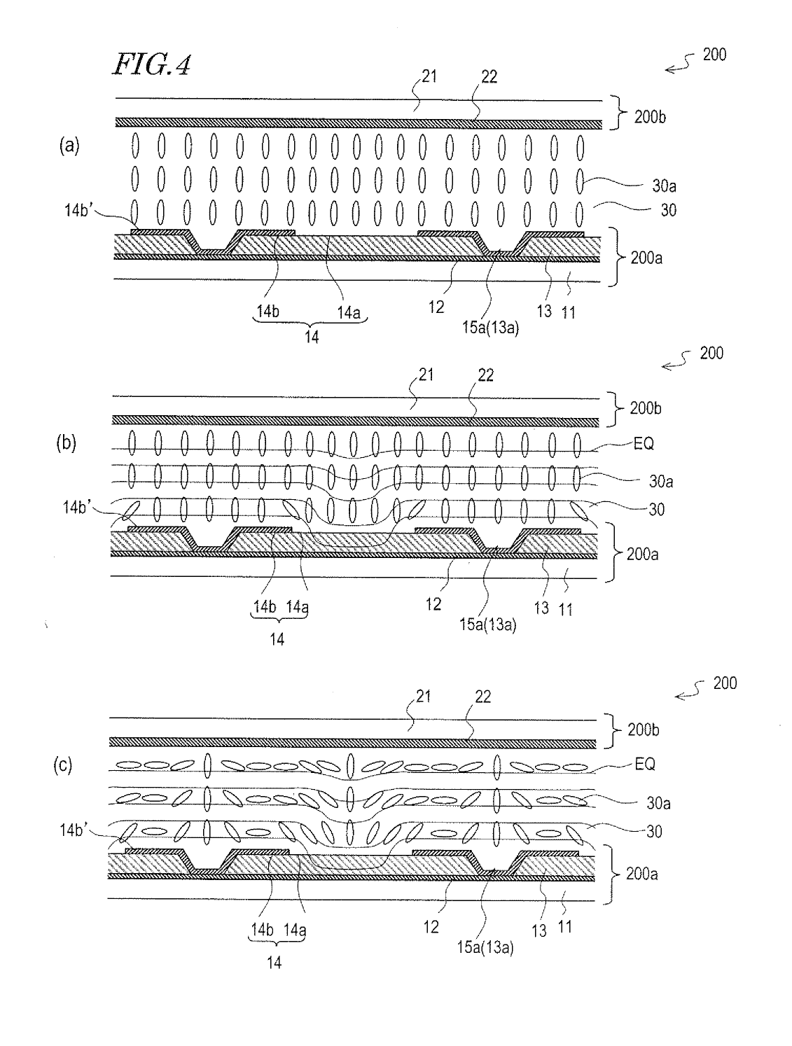

Now, with reference to FIGS. 3 and 4, a structure and an operation of a liquid crystal display device 200 in another embodiment according to the present invention will be described. In the following description regarding the figures, identical elements to those in the liquid crystal display device 100 shown in FIGS. 1 and 2 bear the same reference numerals thereto and the descriptions thereof will be omitted.

FIGS. 3(a) and 3(b) schematically show a structure of the liquid crystal display device 200 in the another embodiment according to the present invention. FIG. 3(a) is a plan view of a picture element region of the liquid crystal display device 200, and FIG. 3(b) is a cross-sectional view taken along line 3B-3B′ in FIG. 3(a).

The liquid crystal display device 200 includes a TFT substrate 200a, a counter substrate 200b, and a liquid crystal layer 30 provided between the TFT substrate 200a and the counter substrate 200b. Liquid crystal molecules 30a in the liquid crystal layer 30 have a negative dielectric anisotropy. When no voltage is applied across the liquid crystal layer 30, the liquid crystal molecules are aligned vertical to a surface of, and by virtue of, a vertical alignment film (not shown) provided on a surface of each of the TFT substrate 200a and the counter substrate 200b, the surface being on the side of the liquid crystal layer 30.

Unlike the liquid crystal display device 100, the liquid crystal display device 200 includes a lower electrode 12 facing the opening 14a and the cutout area 14a′ (i.e., the non-solid areas) of the picture element electrode 14 with the dielectric layer 13 interposed therebetween. Like the connecting line 12a in the liquid crystal display device 100, the lower electrode 12 is connected to the drain electrode of the TFT, and is electrically connected to the picture element electrodes 14 in the holes 13a of the dielectric layer 13. Each picture element electrode 14 is formed so as to cover the holes 13a in the dielectric layer 13 and has recesses 15a at positions corresponding to the holes 13a. The picture element electrode 14 will be occasionally referred to as an “upper electrode 14”. In this case, an assembly of the upper electrode 14 and the lower electrode 12 will be occasionally referred to as a “two-layer structure picture element electrode”.

In the example of FIGS. 3(a) and 3(b), the lower electrode 12 provided so as to face the opening 14a with the dielectric layer 13 interposed therebetween is present in correspondence with the solid area of the picture element electrode 14 as well as in a region overlapping the opening 14a. The arrangement of the lower electrode 12 is not limited to this. The lower electrode 12 does not need to be provided so as to face the entirety of the opening 14a. A portion of the lower electrode 12, which is located to face the conductive layer of the picture element electrode 14 with the dielectric layer 13 interposed therebetween, does not substantially influence the electric field applied to the liquid crystal layer 30. The lower electrode 12 does not need to be patterned for this reason, but may be patterned.

As schematically shown in FIGS. 3(a) and 3(b), the picture element electrode 14 of the liquid crystal display device 20 in this embodiment has a recess 15a, concaved in a thickness direction of the liquid crystal layer 30, substantially at the center of each unit solid area 14b′. Therefore, like in the liquid crystal display device 100, a radially inclined alignment domain can be stably formed.

Now, with reference to FIGS. 4(a) through 4(c), an advantage provided by the lower electrode 12 of the liquid crystal display device 200 will be described. FIG. 4(a) schematically shows a state where no voltage is applied across the liquid crystal layer 30. FIG. 4(b) schematically shows a state where the alignment of the liquid crystal molecules 30a has just started to change (initial ON state) in accordance with the voltage applied across the liquid crystal layer 30. FIG. 4(c) schematically shows a state where the alignment of the liquid crystal molecules 30a, which has been changing in accordance with the applied voltage, has reached a steady state. In FIGS. 4(b) and 4(c), curves EQ represent equipotential lines.

FIGS. 4(a) through 4(c) correspond to FIGS. 2(a) through 2(c). The mechanism by which the radially inclined alignment domains are formed in the liquid crystal display device 200 is the same as that in the liquid crystal display device 100. The structure and the function of the picture element electrode 14 and the recess 15a of the liquid crystal display device 200 are substantially the same as those of the liquid crystal display device 100.

As shown in FIG. 4(a), where the picture element electrode 14 and the counter electrode 22 are at the same potential (where no voltage is applied across the liquid crystal layer 30), the liquid crystal molecules 30a in the picture element region are aligned vertical to a surface of each of the substrates 11 and 21.

When a voltage is applied across the liquid crystal layer 30, a potential gradient represented by the equipotential lines EQ shown in FIG. 4(b) is produced. In a region of the liquid crystal layer 30 which is between the picture element electrode 14 and the counter electrode 22, a uniform potential gradient represented by a portion of the equipotential lines EQ which is parallel to the surfaces of the picture element electrode 14 and the counter electrode 22 is produced. In a region of the liquid crystal layer 30 which is above the opening 14a of the picture element electrode 14, a potential gradient corresponding to the potential difference between the lower electrode 12 and the counter electrode 22 is produced. Since the potential gradient formed in the liquid crystal layer 30 is influenced by a voltage drop caused by the dielectric layer 13 at this point, the equipotential lines EQ formed in the liquid crystal layer 30 drop in regions corresponding to the openings 14a (a plurality of “troughs” are formed in the equipotential lines EQ). The lower electrode 12 is formed so as to face the opening 14a with the dielectric layer 13 interposed therebetween. Therefore, a potential gradient represented by the equipotential lines EQ parallel to the surfaces of the picture element electrode 14 and the counter electrode 22 are formed also in a region of the liquid crystal layer 30 which is above the center of each opening 14a and the vicinity thereof (“flat bottom of the trough” of the equipotential lines EQ). In a region of the liquid crystal layer 30 which is above the edge of the opening 14a (a peripheral portion of the opening 14a including an external boundary of the opening 14a), an oblique electric field represented by an inclined portion of the equipotential lines EQ is produced.

When the voltage applied across the liquid crystal layer 30 approaches a saturation voltage, as shown in FIG. 4(c), the radially inclined alignment domains are formed in regions corresponding to the unit solid areas 14b′ and also in a region corresponding to the opening 14a. The liquid crystal molecules in the radially inclined alignment domain corresponding to the unit solid area 14b′ are aligned like an umbrella opened with the tip directed upward, whereas the liquid crystal molecules in the radially inclined alignment domain corresponding to the opening 14a are aligned like an umbrella opened with the tip directed downward. As shown in the figure, the alignment of the liquid crystal domain corresponding to the unit solid area 14b′ and the alignment of the liquid crystal domain corresponding to the opening 14a are continuous (matched) to each other. Therefore, the alignment of the liquid crystal molecules 30a in the liquid crystal layer 30 is stabilized.

The following is clear from the comparison of FIGS. 4(b) and 4(c) against FIGS. 2(b) and 2(c). In FIGS. 2(b) and 2(c), the equipotential lines EQ drop in a region corresponding to the opening 14a but the trough of the equipotential lines EQ does not have a flat bottom. By contrast, in FIGS. 4(b) and 4(c), the trough of the equipotential lines EQ has a flat bottom in a region corresponding to the opening 14a (i.e., the region in which the lower electrode 12 is exposed as seen from the liquid crystal layer 30). Thus, the inclining angle of the liquid crystal molecules 30a in the region corresponding to the opening 14a is smaller in FIG. 4(c) than in FIG. 2(c). In general, a liquid crystal display device of a vertical alignment mode using a nematic liquid crystal material having a negative dielectric anisotropy displays images in a normally black mode. Therefore, the liquid crystal display device 200 (FIG. 4) displays brighter images than the liquid crystal display device 100 (FIG. 2).

Accordingly, in the case where a plurality of openings 14a are formed in each picture element region at a relatively high density for the purpose of, for example, improving the response speed, the provision of the above-described two-layer structure picture element electrode offers an advantage that the display luminance can be suppressed from decreasing.

Now, with reference to FIGS. 5 through 8, various structures of the picture element electrode 14 adoptable in liquid crystal display devices in embodiments according to the present invention will be described. The structures of the picture element electrode 14 described below are applicable for the picture element electrode 14 of the liquid crystal display device 100 or the picture element electrode (upper conductive layer) 14 of the liquid crystal display device 200. In FIGS. 5 and 6, the connecting line 12a of the liquid crystal display device 100 and the lower electrode 12 of the liquid crystal display device 200 are omitted, but the positional relationship and the connection relationship thereof with the picture element electrode 14 is as described above with reference to FIG. 1.

As a picture element electrode of a liquid crystal display device in an embodiment according to the present invention, any of picture element electrodes 14A and 14B respectively shown in FIGS. 5(a) and 5(b) is usable.

In each of the picture element electrodes 14A and 14B, generally cross-shaped openings 14a are arranged in square lattices such that each unit solid area 14b′ has a generally square shape. A cutout area 14a′ is provided such that the unit solid areas 14b′ have the same shape. These unit solid areas may be distorted so as to form oblong rectangular unit lattices, needless to say. The generally rectangular unit solid areas 14b′ which are regularly arranged in this manner also realize a liquid crystal display device having a high display quality and a superb viewing angle characteristic (the term “rectangular” encompasses square and oblong rectangular).

As for the shape of the openings 14a and/or the unit solid areas 14b′, a circular or elliptical shape is preferable because such a shape stabilizes the radially inclined alignment. The conceivable reason why the circular or elliptical shape stabilizes the radially inclined alignment is that the sides of the opening 14a are more continuous (continue more smoothly) and so the alignment direction of the liquid crystal molecules 30a also changes more continuously (smoothly).

From the viewpoint of the response speed, picture element electrodes 14C and 14D respectively shown in FIGS. 6(a) and 6(b) are usable. The picture element electrode 14C shown in FIG. 6(a) is a modification of the picture element electrode 14A shown in FIG. 5(a) including square unit solid areas 14b′. Each unit solid area 14b′ of the picture element electrode 14C has a shape of a deformed square with acute corners. The picture element electrode 14D shown in FIG. 6(b) includes generally star-shaped unit solid areas 14b′ each having eight sides (edges) and a four-fold rotation axis at the center thereof. The four corners of the star shape are each acute. The “acute corner” means a corner formed of two straight or curved lines making an angle of less than 90 degrees.

In a liquid crystal display device in which the alignment of the liquid crystal molecules 30a is controlled by an oblique electric field generated in an edge of the opening 14a, when a voltage is applied across the liquid crystal layer 30, the liquid crystal molecules 30a above the edge are first inclined, and then the liquid crystal molecules 30a in a surrounding region are inclined to take a radially inclined alignment. For this reason, the response speed may occasionally be lower than that of a liquid crystal display device of a display mode by which the liquid crystal molecules 30a above the picture element electrode are inclined at the same time upon application of a voltage across the liquid crystal layer.

Where the unit solid area 14b′ has acute corners as shown in FIGS. 6(a) and 6(b), a larger number of edges for generating an oblique electric field are formed, and therefore the oblique electric field can act on a larger number of liquid crystal molecules 30a. Thus, the number of liquid crystal molecules 30a which first start to incline in response to the electric field is increased, which shortens the time required for forming radially inclined alignment domains in the entire picture element region. As a result, the response speed to the application of a voltage across the liquid crystal layer 30 is improved.

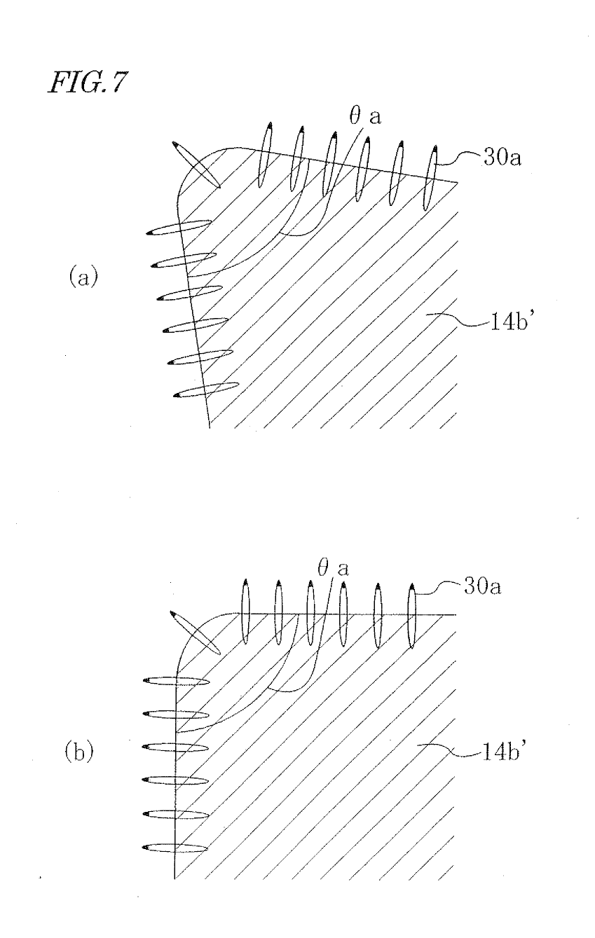

For example, it is assumed that in a liquid crystal display device in which each unit solid area 14b′ has a side of about 40 μm, the unit solid area 14b′ has a shape of the deformed square shown in FIG. 6(a) and the corners of the square have angle θa of less than 90 degrees (for example, about 80 degrees) as shown in FIG. 7(a). It is also assumed that in the same type of liquid crystal display device, each unit solid area 14b′ has a generally square shape with rounded corners as shown in FIG. 5(b) and the corners thereof have angle θa of 90 degrees as shown in FIG. 7(b). In the former structure, the response speed upon application of a voltage across the liquid crystal layer 30 can be made shorter by about 60% than in the latter structure. With the star-shaped unit solid areas 14b′ as shown in FIG. 6(b) also, the response speed can be made shorter in the same manner.

With the unit solid area 14b′ having acute corners, the probability at which the liquid crystal molecules 30a aligned at a specific azimuth angle are present can be made higher (or lower) than with the generally circular or generally rectangular unit solid area 14b′. Namely, the probability at which the liquid crystal molecules 30a aligned at each of all the azimuth angles are present can be given a higher level of directivity. Accordingly, in a liquid crystal display device including polarization plates for allowing linear polarization to be incident on the liquid crystal layer 30, the provision of the unit solid area 14b′ with acute corners can decrease the probability, at which the liquid crystal molecules 30a aligned vertical or parallel to the polarization axes of the polarization plates, i.e., the liquid crystal molecules 30a providing no phase shift to the incident light, are present. As a result, the light transmittance can be improved and brighter display can be realized.

When the corners of the unit solid area 14b′ are made acute as described above, the oblique electric field generated by the picture element electrode 14 is not sufficient to keep the stability of the radially inclined alignment domains in some occasions. For example, in the case where the unit solid area 14b′ has acute corners, the sides of the opening 14a do not continue as smoothly as in the case where the unit solid area 14b′ is generally circular. Therefore, the alignment directions of the liquid crystal molecules 30a do not continue sufficiently well. As a result, with only the alignment regulating force provided by the oblique electric field, the stability of the radially inclined alignment domains may occasionally decrease. Nevertheless, the picture element electrode of the liquid crystal display device in this embodiment has a recess 15a, which provides an alignment regulating force for keeping the radially inclined alignment domain sufficiently stable for practical use.

In the liquid crystal display device in the above-described embodiment, each picture element region includes a plurality of openings 14a. A plurality of liquid crystal domains can be formed in each picture element region by providing only one opening 14a in each picture element region. Even without the opening 14a, a plurality of liquid crystal domains can be formed in each picture element region. As long as a liquid crystal domain taking a radially inclined alignment is formed in correspondence with the unit solid area 14W, it is not necessary that the liquid crystal domain formed in correspondence with the opening 14a should take a radially inclined alignment. Even without the radially inclined alignment in correspondence with the opening 14a, the alignment of the liquid crystal molecules in the picture element region can be continuous, and thus the radially inclined alignment of the liquid crystal domain formed in correspondence with the unit solid area 14b′ is stabilized. Especially where the openings 14 have a small area as shown in FIGS. 5(a) and 5(b), the contribution thereof to the display is also small. Therefore, even if the liquid crystal domain taking a radially inclined alignment is not formed in a region corresponding to the opening, the display quality decline is not considered as a problem.

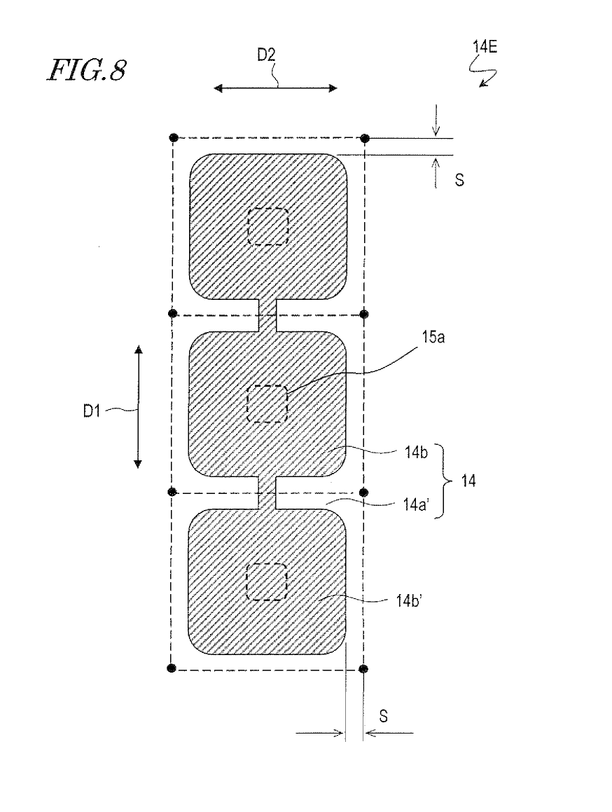

A picture element electrode 14E shown in FIG. 8 does not have any opening unlike in the above-described examples. The picture element electrodes 14E, which are arranged in a matrix of rows and columns, each include three unit solid areas 14b′ arranged in a line in a column direction D1. Each unit solid area 14b′ has a barrel shape which is a generally square shape with rounded corners. The contour of each unit solid area 14b′ is defined by the cutout area 14a′. When a voltage is applied across the liquid crystal layer, a radially inclined alignment domain is formed in correspondence with each unit solid area 14b′ and also the center of the radially inclined alignment is located in the recess 15a by the alignment regulating force of the oblique electric field generated in a peripheral portion of each unit solid area 14b′ and the alignment regulating force of the recess 15a, like in the liquid crystal display devices in the embodiments described above.

Referring to FIG. 8, the length of the gap between the square unit lattice formed by the cutout area (non-solid area) 14a′ and the unit solid area 14b′ (i.e., the length of the space along one side of the unit solid area 14b′) is set to s. The space s along one side needs to have at least a predetermined length in order to generate an oblique electric field required for obtaining a stable radially inclined alignment.

The space s along one side is defined in a row direction D2 and also in the column direction D1. As described in Japanese Laid-Open Patent Publication No. 2002-202511, picture element electrodes adjacent to each other in the row direction D2 may be driven in an inverting manner. In this case, a sufficient alignment regulating force can be provided even if the space s along one side in the row direction D2 is smaller, unlike in the case where such picture element electrodes are not driven in the inverting manner. This occurs because when the picture element electrodes adjacent to each other in the row direction D2 are driven in the inverting manner, a stronger oblique electric field can be generated than when such picture element electrodes are not driven in the inverting manner. In the embodiment of FIG. 8, the alignment regulating force of the recess 15a acts to stabilize the radially inclined alignment. Therefore, the distance between the picture element electrodes 14 adjacent to each other in the row direction D2 can be further shortened than in the case of Japanese Laid-Open Patent Publication No. 2002-202511.

### INDUSTRIAL APPLICABILITY

The present invention is applicable to at least a liquid crystal display device which displays images in a transmission mode, for example, a typical transmissive liquid crystal display device, and also to a transreflective (semi-transmissive) liquid crystal display device.

The present invention, which provides a highly stable liquid crystal alignment state, is applicable especially preferably to a liquid crystal display device for uses in which a stress is likely to be applied to the liquid crystal panel.

1. A liquid crystal display device, comprising:
a first substrate, a second substrate, and a liquid crystal layer of a vertical alignment type provided between the first substrate and the second substrate; and
a picture element region defined by a first electrode provided on a surface of the first substrate, the surface being on the side of the liquid crystal layer, and a second electrode provided on the second substrate and facing the first electrode with the liquid crystal layer interposed therebetween;
wherein:
in the picture element region, the first electrode includes a solid area formed of a conductive layer and a non-solid area with no conductive layer; the solid area includes a plurality of unit solid areas each substantially surrounded by the non-solid area; and each of the plurality of unit solid areas has a recess, concaved in a thickness direction of the liquid crystal layer, at a substantially central position thereof; and
when a voltage is applied between the first electrode and a second electrode, the liquid crystal layer forms a liquid crystal domain taking a radially inclined alignment in correspondence with each of the plurality of unit solid areas by an oblique electric field generated in an edge of the non-solid area, and also locates a center of the radially inclined alignment in the recess.

2. The liquid crystal display device of claim 1, wherein the liquid crystal display device includes a dielectric layer provided in the picture element region on a surface of the first electrode, the surface being on the side of the first substrate; the dielectric layer has a recess or a hole; and the plurality of unit solid areas each have the recess in correspondence with the recess or the hole of the dielectric layer.

3. The liquid crystal display device of claim 2, further comprising a third electrode in the picture element region, the third electrode facing the non-solid area of the first electrode with the dielectric layer interposed therebetween.

4. The liquid crystal display device of claim 3, wherein the dielectric layer has at least one hole exposing the third electrode; and at least one of the plurality of unit solid areas is connected to the third electrode in the at least one hole.

5. The liquid crystal display device of claim 1, wherein the alignment of the liquid crystal domain and the alignment in a region of the liquid crystal layer corresponding to the non-solid area are continuous to each other.

6. The liquid crystal display device of claim 5, wherein:
the non-solid area has an opening substantially surrounded by the plurality of unit solid areas; and
when a voltage is applied between the first electrode and the second electrode, the liquid crystal layer forms a liquid crystal domain taking a radially inclined alignment also in a region of the liquid crystal layer corresponding to the opening.

7. The liquid crystal display device of claim 1, wherein in the picture element region, the second electrode has a continuous surface which is parallel to a surface of the second substrate.

8. The liquid crystal display device of claim 1, wherein when no voltage is applied between the first electrode and the second electrode, liquid crystal molecules in a region of the liquid crystal layer on the side of the second electrode are aligned substantially vertical to a surface of the second substrate.
